(19) United States
(12) Patent Application Publication
(10) Pub. No.: US 2015/0212902 A1
(43) Pub. Date: Jul. 30, 2015

(54) NETWORK ATTACHED STORAGE DEVICE WITH AUTOMATICALLY CONFIGURED DISTRIBUTED FILE SYSTEM AND FAST ACCESS FROM LOCAL COMPUTER CLIENT

(71) Applicant: Nigel David Horspool, Great Missenden (GB)

(72) Inventor: Nigel David Horspool, Great Missenden (GB)

(21) Appl. No.: 14/164,887

(22) Filed: Jan. 27, 2014

(51) Int. Cl. G06F 11/14; G06F 3/06; G06F 17/30

(52) U.S. Cl. CPC G06F 11/1464; G06F 17/30091; G06F 3/0619; G06F 3/065; G06F 3/067

(57) ABSTRACT

A network attached storage device that has dual network ports and internal network bridge with a method for automatically configuring a distributed file system allowing multiple devices to be connected directly to computer clients while presenting an amalgamation of all the devices into a single large storage element. Electronic files stored on the storage element are automatically replicated so that a failure of one of the network attached storage devices will not result in the loss of data, and the multiple devices will automatically incorporate additional units to present a larger amalgamated storage element to the computer clients. These methods simplify the use of the storage devices and allow multiple computer clients simultaneous very fast access to files on the local devices.

### CROSS-REFERENCED TO RELATED APPLICATIONS

Status: Continuation of provisional patent application to non-provisional application

U.S. Provisional Patent Application No. 61,758,018

Confirmation Number 9424

Filing Date 29 Jan. 2013

### CROSS-REFERENCED TO RELATED APPLICATIONS

Status: Continuation

GB Patent Application Number 1118151.8

Filing Date 20 Oct. 2011

### STATEMENT REGARDING FEDERALLY SPONSORED RESEARCH OF DEVELOPMENT

Not Applicable

### MICROFICHE APPENDIX

Not Applicable

### BACKGROUND

The invention relates to external computer storage devices, of which two main categories of devices are available: Direct Attached Storage (DAS), which plugs directly into a single computer typically using a USB interface, and Network Attached Storage (NAS) where multiple computers can be connected to the product simultaneously typically using Ethernet or wireless connections through a computer network system.

DAS devices have less functionality than NAS devices and are therefore cheaper, and they are easier to use, but NAS devices allow multiple users to simultaneously access the files that are stored on the storage device. These NAS based systems typically use high-level file access software applications, based on the Common Interface File System (CIFS) protocol, which transfer files in multiple small blocks of data, thereby allowing simultaneous access to files from multiple computer clients by the use of interleaving of data transfers to the different clients.

External computer storage devices are based on two main components; the storage element and an electronic bridge circuit. A Hard-Disk-Drive is most cost effective for high capacity storage elements and numerous types of these drives are available, from lower cost, power and performance devices to high-end devices that have higher performance, though consume more power and cost more. A Hard-Disk-Drive consists of several components including storage platters and read-write heads; one of the critical aspect of the disk performance, reliability and power consumption is the head seek speed which is the time taken to move the heads between different tracks on the platter required when accessing different files on the device. When multiple computer clients simultaneously access a NAS device, the Hard-Disk-Drive heads have to move frequency as the files will be stored at different parts of the storage platter. However, when there are no accesses, the Hard-Disk-Drive can automatically enter a low power standby state that improves reliability and reduces power consumption.

NAS devices for businesses can be categorised in to two main areas; large business NAS devices and small/medium business NAS devices:

Large Business NAS

Large businesses have several storage requirements; very large storage for company data often supporting multiple buildings with many staff with very fast access to the data, very high level of reliability in the access to the data, the ability to easily change the amount of storage available to each user and department, protection of data. The performance, reliability, protection and flexibility is typically more important than the cost of the storage devices, since many large businesses need uninterrupted access to the stored data.

To cope with these requirements large businesses use very high-end NAS devices, often called enterprise servers; each device contain many HDDs, for example 12-32 HDDs, have very high performance computer processing units (CPUs) and require specialised IT personnel to configure the systems and provide day-to-day management of these devices. They are often housed in racks of units and require a temperature controlled environment and typically use enterprise hard disk drives which, though more expensive than consumer drives, have longer life. These high-end NAS servers have features that allow the IT professionals easy management of the systems including virtualization and distributed file systems.

Virtualization allows an IT specialist to combine a number of physical storage devices so that they appear as a single larger storage device and these ‘virtual’ storage devices can be dynamically increased when the storage is becoming full. This virtualization of the storage, requires an extra level of complex software to be run on the storage system, but it simplifies how users of these devices, via their PC or laptop, view the storage; the users' computer network map will present a single network device rather than many devices

Distributed file systems are used by very high-end NAS devices to share files and computing power between several server systems. Typically these must be configured by IT specialists.

Small-Medium Business NAS

Small-medium businesses (SMB) have several storage requirements; large amounts of low cost storage for company data, fast access to the data, protection of the data, and easy to use without the need for specialist IT knowledge.

Currently available SMB NAS devices provide storage for small businesses; to provide the large amounts of storage and to protect the data, business NAS devices will often contain multiple hard-disk-drives, typically 2 to 8 HDDs, but often use the high-end drives, higher cost and power drives, to provide the fast data access. These NAS systems often contain complex functions that require a level of storage expertise not found in many small and medium businesses to configure, for instance redundant-array-of-independent-disks (RAID) technology that protects the data by storing parts of the file on multiple HDDs and storing a checksum on another HDD. These NAS devices often support several RAID technology options, the most efficient require that parts of each file are stored on all HDDs, so that none of the HDDs can be in standby mode when any client is accessing files.

Local Computer Network

Traditional NAS devices require a fully functional local network based on Ethernet switches or wireless access points that connect computers to central storage NAS products; the performance of the network can be significantly reduced if an inexperienced user has installed a single low performance network switch or router device into the local network. A typical Ethernet network contains client desktop personal computers and mobile devices such as laptop computers connected to a Network-Attached-Storage device using Ethernet cables or wireless technology via an Ethernet switch or router. Every device on the local network is assigned a unique identification called the Internet Protocol (IP) address which is often mapped to network domain name. The configuration of the Internet Protocol address for network devices can often mean that new equipment added to the network is not accessible by the client computers until initialization software is run on the client computers, complicating the installation of new devices.

Computer networks that use virtualization typically contain multiple virtual servers with redundancy enabled so that users can still access their data, even after a failure of a single server. Each of the virtual servers will be assigned a different Internet Protocol (IP) Address using standard techniques, but the users' computer will connect to only one of the servers at any one time. For these redundant virtual systems, the setup is often complex, since the list of server IP addresses must be identified and the list of addresses either loaded on to every client computer, or on to network configuration application software run by network servers, routers or other network devices; each method requires detailed understanding of computer network setup typically requiring specialist IT knowledge.

Network and Current Network Attached Storage Device Limitations

There are several limitations of current Network Attached Storage devices for small businesses since all clients access the same device; firstly, the local network can be poorly configured creating network bottlenecks that impact file access performance, secondly, each client simultaneously accessing data from the multiple hard-disk-drives of the NAS device require frequent disk head seeks reducing the maximum file transfer performance and significantly increasing power consumption, thirdly, many small businesses use wireless technology, built into portable devices such as laptop computers and tablet computers, that has a data transfer performance 1/10^{th} of the speeds available with Gigabit Ethernet to connect to the storage device and internet and fourthly current business NAS devices have initial configuration requirements that if often too complex for typical small and medium businesses without specialized Information Technology (IT) knowledge.

### BRIEF DESCRIPTION OF INVENTION

The present invention comprises a network attached storage device that has dual network ports and internal network bridge with a method for automatically configuring a distributed file system allowing multiple devices to be connected directly to computer clients while presenting an amalgamation of all the devices into a single large storage element. The internal bridge optionally filters Ethernet packet data so that each computer client uses a single network domain name, but is communicating to the storage to which it is directly connected.

The invention is configured so that electronic files stored on the storage element are automatically replicated so that a failure of one of the network attached storage devices will not result in the loss of data.

The invention includes functionality which allows the multiple devices to automatically incorporate additional units to present a larger amalgamated storage element to the computer clients, and to share user configuration data with the additional units.

The invention optionally provides automatic compression of the electronic files stored on the device, and a method for the storage devices to share electronic files and configuration data directly across a wireless network without the need for a wireless access point where a wired Ethernet connection is unavailable.

In view of the above, it can be seen that a significant advantage of this invention is that it allows the storage devices to be connected easily between the client computers and the local Ethernet network which provides speed and power consumption benefits, regardless of local computer network performance, and enables the use of low cost components. Furthermore, it provides extra simplicity for the user; both initial configuration and everyday use of the storage devices without specialised storage knowledge; the invention provides automatically configured advanced features that protect file data against device failure and allows simple fast expansion of the amalgamated storage element. The invention allows businesses to easily expand their storage network with low cost storage elements as their storage requirements increase without specialist Information Technology knowledge.

### BRIEF DESCRIPTION OF THE DRAWINGS

FIG. 1 schematically represents a current standard small/medium business computer network containing client desktop and mobile computers that are simultaneously accessing a Network Attached Storage device via a network device such as a switch or router. The Network Attached Storage device has to respond to multiple simultaneous client computer file accesses.

FIG. 2 schematically shows the Network Attached Storage functionality is distributed amongst multiple storage devices that are connected directly to both the client computers and the local computer network with an internal Ethernet bridge, with the device running a distributed file system so that each client computer will see a single large storage element regardless of the number of physical devices, according to an embodiment of the invention.

### DETAILED DESCRIPTION OF THE INVENTION

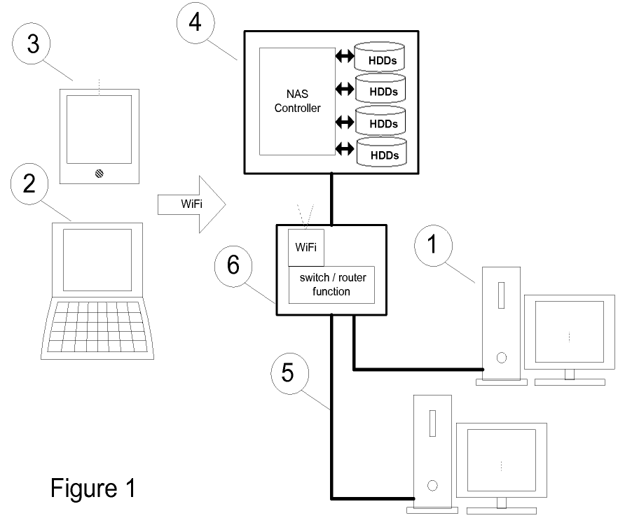

The present invention is generally applicable to Network Attached Storage in consumer or business networks, and in particular for small and medium sized business where multiple users need easy access to files stored on shared storage and where there is limited Information Technology (IT) knowledge within the business. FIG. 1 shows a typical Ethernet network with client PCs 1, laptops 2 and tablet computers 3 connected to a Network-Attached-Storage device 4 using Ethernet cables 5 or wireless technology via an Ethernet switch or router 6. Every device on the local network is assigned a unique identification called the Internet Protocol (IP) address. As understood by the art, the Network Attached Storage device 4 uses high-level file access software applications, based on the Common Interface File System (CIFS) protocol, which transfer files in multiple small blocks of data, thereby allowing simultaneous access to files from multiple computer clients by the use of interleaving of data transfers to the different clients.

There are several limitations of these devices for small businesses since all clients access the same device; firstly, the local network can be poorly configured creating network bottlenecks that impact file access performance, secondly, each client simultaneously accessing data from the multiple hard-disk-drives of the NAS device require frequent disk head seeks reducing the maximum file transfer performance and significantly increasing power consumption

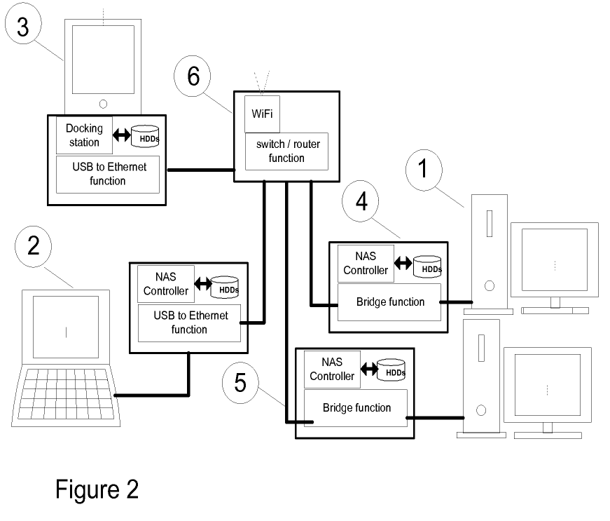

To overcome these limitations, the present invention proposes a method of distributing the Hard Disk Drives (HDD) into a plethora of storage devices containing just a single or dual disk that have two network ports with an internal Ethernet bridge which allows the unit to be connected between the client PC/laptop and the rest of the network as shown in FIG. 2. Each device runs software that provides a distributed file system with virtualisation so that each client computer (desktop PC, laptop, tablet device or smart phone) is presented with an amalgamation of all the devices into a single storage element. The amalgamation of the storage is achieved using virtualization software application as understood by the art; currently this type of software is only run on high-end enterprise-level storage servers.

A key feature of this invention is that it combines a number of features that allow easy installation and day-to-day usage of the storage elements. A typical network configuration, as shown in FIG. 1, requires installation software to be run on the client computers which attempts to discover the storage device on the network, and for the customer to input numerous configuration data into set-up WEB pages The invention optionally proposes a method whereby the storage device can automatically extract the network Internet Protocol Address of the client computer that is directly connected to one port of its internal Ethernet Bridge and will use that information to define its own Internet Protocol Address or configure application software running on the storage device to automatically request an address from a network address server. The internal Ethernet Bridge optionally filters protocol packet data, so that the domain name requests will be processed by the storage device rather than the network domain name server. The storage device will automatically discover names and IP Addresses from the network domain server, and present a filtered list of IP names and addresses to the local client PC; the IP Address mapped to the storage element domain name is set to the IP Address of the local storage device, so that any file request to the storage element will be processed by the local device. If the file data is not stored on the local hard-disk-drive, for instance in the case of a hard-disk-drive failure in the local device, the storage controller of the local device automatically requests the data from one of the other storage devices on the local network and automatically forwards the data to the client PC. This means that the user of the local client PC is unaware of where the data is stored and can access data even following a local hard-disk-drive failure. The invention also optionally configures the storage device with a public and private file directory, and with the automatic IP Address and domain name configuration as defined above, the device can be used without any user setup.

The invention includes the automatic copying of files to two or more storage devices to provide protection of files, even when individual storage devices break, for instance due to hard-disk-drive failures. The invention proposes a method that the primary copy of the file will be stored on the device that is connected directly to the computer client that created or modified the file. Typically, it will be the same computer client that subsequently accesses the file rather than a different client, meaning that file data does not need to traverse the local computer network and multiple clients will be accessing the storage device directly connected to their computer. The HDD within the storage device will be accessing a single file so head seeks will be minimised.

Furthermore, the invention provides a method for automatically moving infrequently accessed files stored on devices containing an HDD that is becoming full to less full storage devices on the local network. This provides a method for continuing to store the primary copy of the most frequently accessed files to be stored on the device that is connected directly to the computer client that created or modified the file even when the local storage device is becoming full.

Typically, Network Address Storage devices that contain multiple hard-disk drives with redundancy can only fully utilize the capacity of hard-disk drives that have the same capacity; this patent optionally supported redundancy across hard-disk drives of different capacity.

The invention also includes an option for the flies to be automatically electronically compressed to increase the number of files that can be stored by the devices. Optionally, to increase the speed of transfers between the client computer and locally connected storage device, primary copies of the files may not be compressed immediately; the decision of when to compress the primary copy will be dependant on a number of factors including the performance of the storage device processing unit, the frequency of the accesses to the file and the overall load on the storage devices.

A further option of the invention is for the storage devices to keep previous versions of modified files which can be accessed by the user if a file has been accidentally deleted or incorrectly modified.

The methods in the invention provide a unique device that enables the use of low cost components while providing high performance file transfers, simplicity for the user without specialised storage knowledge with automatically configured advanced features that protect file data against device failure and allows simple fast expansion of the amalgamated storage element. The invention allows the storage devices to be connected easily between the client computers and the local Ethernet network which provides speed and power consumption benefits.

Optionally the storage device will contains a USB device port that can be connected to portable devices using USB connection with the client device running the network protocol TCP-IP rather than an Ethernet or wireless connection. This is used for computer devices that do not have a wired Ethernet port, such as some tablet computer or smart phones. This provides an alternative, from a wireless connection, access route to the storage devices that is not impacted by the wireless network loading.

Optionally the storage device will contain a USB device port which will be used for initial configuration of the devices; the USB device is configured to automatically run software on the client computer that simplifies the steps for the installation including wizards. The configuration will provide an option for creating a private storage space for each user in addition to a (reduced size) amalgamated storage element.

This invention also includes a method for automatically providing network and storage device status by running a background software program on the client computer that periodically extracts the status data from the storage devices. This program is optionally loaded on to the client computer as part of the installation process. The storage devices run network analysis tools, communicating between the devices and analyzing the data flow across the internal Ethernet bridge to generate network status information. The method provides an option to email or text the status information to a user.

In addition, the storage device will optionally support a Hard-Disk-Drive hot-plug function, where an HDD is connected to the electronic bridge circuit board while power is supplied to the board and the system recognises the event and automatically runs software that incorporated the HDD into the system to provide a fully functional storage device. This option would be used to simplify the installation of storage devices that are shipped without an internal HDD. Alternatively it provides a simple method for swapping an HDD from an existing device where the HDD has broken or to provide a large HDD for the storage device.

Additionally, the storage device optionally includes a wireless function for use in wireless networks that allows the devices to automatically communicate directly between each other without the need for using a wireless access point which provides higher performance data transfers.

The invention provides the option for the group of storage devices to provide secure access to the storage element from the internet by automatically communicating with a security server in the internet. The client computer will contain software program that connects to the internet security server using security software and security certificates, which then provides the connection to the storage devices. This program and certificates are optionally loaded on to the client computer as part of the installation process to simplify the steps needs by the user to remotely connect to the storage devices via the internet.

The invention is also suitable for inclusion into other devices such as laptop computer, computer tablets and smart phone docking stations. These devices will optionally automatically copy data, for example phone contact information, stored on the portable device on to the storage unit.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A network attached storage apparatus comprising:
a network attached storage controller device comprising a processor function, interfaces to connect to an Ethernet network and an interface to a storage element;
network attached storage software executable on the network attached storage controller device;
storage element for the storage of electronic files with standard storage interface bus;
an Ethernet network bridge with dual Ethernet network ports, allowing the storage apparatus to be connected directly to a computer client through one network port and connected to a local computer network with the other network port, the internal Ethernet bridge provides bridging of computer network traffic between the two ports with an additional functionality to filter packet data from the storage devices to each computer client so the user sees a single network device with a single network domain name;
software that provides a distributed file system with virtualisation, running on the network attached storage controller device with a method to automatically configure the distributed file system across multiple storage apparatus that are connected via a local computer network directly to computer clients, the file system presents an amalgamation of all the storage apparatus into a single large storage element to each of the computer clients;
software which automatically copies electronic files stored on the storage element to storage apparatus on the local network, so that a failure of one of the network attached storage devices will not result in the loss of data;
software that automatically moves infrequently accessed files stored on the device's storage element to less full storage apparatus on the local network, providing a method for continuing to store the most frequently accessed files on the storage device that is connected directly to the computer client.

2. A network attached storage apparatus according to claim 1, in which the device compresses file data before storing the resulting compressed data.

3. A network attached storage apparatus according to claim 1, which comprises of a Universal Serial Bus interface port which is used for initial configuration of the apparatus in which the device emulates a computer Read-Only-Memory drive automatically running a configuration program on the client computer.

4. A network attached storage apparatus according to claim 1, which comprises of a Universal Serial Bus interface port which is used for file accesses to the storage element using a network protocol over the Universal Serial Bus interface.

5. A network attached storage apparatus according to claim 1, in which the apparatus connects to a local computer network using wireless connection instead of the wired Ethernet connection, while connecting to a computer client using wired Ethernet.

6. A network attached storage apparatus according to claim 5, in which the storage apparatus communicate directly over a wireless link to share information and file data without using a wireless router which provides a faster transfer rate compared to connections using a wireless router.

7. A network attached storage apparatus according to claim 1, in which the unit stores previous versions of modified files which can be accessed by the user wanting to retrieve earlier versions of the file.

8. A network attached storage apparatus according to claim 1, in which a hard disk drive is used for the storage element of the device.

9. A network attached storage apparatus according to claim 1, in which the device supports a storage hot-plug function and software to automatically incorporate the storage element into the system following a hot-plug event, to simplify user configuration steps.

10. A network attached storage apparatus according to claim 1, which can be securely accessed from the internet by automatically communicating with a security server in the internet.

11. A network attached storage apparatus according to claim 10, in which file accesses to storage devices on the Internet use secure network protocols using security software and security certificates, without the need for user configuration.

12. A network attached storage apparatus according to claim 1, in which the client computer can be a desktop computer, laptop computer, computer tablets or smart phone docking stations.

13. A network attached storage apparatus according to claim 2, in which the primary copy of the data is not compressed immediately in order to increase the speed of transfers between the client computer and locally connected storage device.

14. A network attached storage apparatus according to claim 1, in which the primary copy of the data is not immediately stored on to other storage apparatus on the local network in order to increase the speed of transfers between the client computer and locally connected storage device; file data is cached on to the local machine before copying across the network.

15. A network attached storage apparatus according to claim 1, in which the locally connected storage device will communicate to other storage elements to identify that a data file is in the process of being updated, to ensure that accesses to the same file by other clients wait until the new data has been copied to the storage apparatus on the local network.

16. A network attached storage apparatus according to claim 1, which can run configuration software that includes a method of creating private storage spaces for users.

17. A network attached storage apparatus according to claim 1, which runs network analysis tools, communicating between the devices and analysing the data flow across the internal Ethernet bridge to generate network status information.

18. A network attached storage apparatus according to claim 1, which supported file redundancy across hard-disk drives of different capacity.

19. A network attached storage apparatus according to claim 1, which supported file redundancy across storage elements of different capacity.

20. A network attached storage apparatus according to claim 1, which automatically discover names and IP Addresses from the network domain server, and present a filtered list of IP names and addresses to the local client PC; the IP Address mapped to the storage element domain name is set to the IP Address of the local storage device, so that any file request to the storage element will be processed by the local device.

21. A network attached storage apparatus according to claim 11, in which security software and security certificates, are automatically copied on to client portable computing devices when they connected directly to the network attached storage apparatus during the configuration process.

22. A network attached storage apparatus according to claim 17, in which network status information is automatically sent to a defined user using an email or text.

23. A network attached storage apparatus according to claim 1, in which other storage devices, such as solid state drives, are used for the storage element of the device.
